(19) United States
(12) Patent Application Publication
(10) Pub. No.: US 2024/0419465 A1
(43) Pub. Date: Dec. 19, 2024

(54) COLLABORATIVE PROMPTING OBJECTS FOR PRODUCTIVITY APPLICATION ENVIRONMENTS

(71) Applicant: Microsoft Technology Licensing, LLC, Redmond, WA (US)

(72) Inventors: Vlad RISCUTIA, Redmond, WA (US); Barnabas James WHITFIELD, Redmond, WA (US); Jonathan Seth KAUFTHAL, Seattle, WA (US); Maya RODRIG, Seattle, WA (US)

(21) Appl. No.: 18/336,098

(22) Filed: Jun. 16, 2023

(51) Int. Cl. G06F 9/451; G06F 40/166

(52) U.S. Cl. CPC G06F 9/453; G06F 40/166

(57) ABSTRACT

Technology is disclosed herein for a large language model (LLM) integration by a collaborative prompt object in an application environment. In an implementation, a computing apparatus identifies a context of a content environment and into which a local instance of a collaborative prompt object is inserted. The computing apparatus generates a prompt for a LLM service to elicit suggestions for follow-on prompts based on content of the content environment. The computing apparatus displays graphical input devices corresponding to the suggestions. The computing apparatus receives user input comprising a selection of a graphical input device of the graphical input devices and generates a follow-on prompt based on the suggestion corresponding to the selected graphical input device.

### TECHNICAL FIELD

Aspects of the disclosure are related to the field of computer hardware and software solutions, and in particular to collaborative integrations between productivity applications and large language model services.

### BACKGROUND

Efficient collaboration is important for productivity and success in various professional fields. Technological solutions for facilitating collaboration include shared documents which multiple users can edit and for which changes are synchronized through a collaboration service or framework. For example, users collaborating on a shared document can view edits made by other users in real time, as well as accept and reject the edits or post comments or engage in dialog with other users. So, too, are there solutions for resolving editing conflicts which might occur amongst multiple users. Other technological solutions for collaboration include online project canvases which allow users to post content for other users' consideration.

New advances in generative artificial intelligence (AI) are changing the content creation landscape: generative AI models have been pretrained on an immense amount of data across virtually every domain of the arts and sciences and have demonstrated the capability of generating responses which are novel, open-ended, and unpredictable. Users can compose prompts to obtain assistance from an AI chatbot with respect to content creation. In return, the AI model supplies suggestions which the user can integrate into a shared document, and the changes are synced via the collaboration framework for other users to view. However, when the other users view the AI-generated content, the source of the content is not obvious, and other users may be ignorant of the process by which the content was generated. Moreover, a prompt composed by a single user may result in suggestions which are sub-optimal with respect to accomplishing the goal of the collaboration effort.

### OVERVIEW

Technology is disclosed herein for a large language model (LLM) integration by a collaborative prompt object in an application environment. In an implementation, a computing apparatus identifies a context of a content environment and into which a local instance of a collaborative prompt object is inserted. The computing apparatus generates a prompt for a LLM service to elicit suggestions for follow-on prompts based on content of the content environment. The computing apparatus displays graphical input devices corresponding to the suggestions. The computing apparatus receives user input comprising a selection of a graphical input device of the graphical input devices and generates a follow-on prompt based on the suggestion corresponding to the selected graphical input device.

In an implementation, the computing apparatus maintains a record of events indicative of prompts, replies, and user interaction with respect to the local instance of the collaborative prompt object. The computing apparatus updates one or more remote instances of the collaborative prompt object based on the record of events.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1A illustrates an operational environment of a collaborative prompt object for an LLM integration in application environment in an implementation.

FIG. 1B illustrates an operational scenario for an LLM integration in application environment in an implementation.

FIG. 2 illustrates a method of operating a relay framework for an LLM integration in an application environment in an implementation.

FIG. 3 illustrates a method of operating a collaborative prompt object for an LLM integration in an application environment in an implementation.

FIG. 4 illustrates a systems architecture for a collaborative system for LLM integration in an application environment in an implementation.

FIG. 5 illustrates an operational scenario of a collaborative prompt object for LLM integration in an application environment in an implementation.

FIGS. 6A-6C illustrate operational scenarios of a collaborative prompt object for LLM integration in an application environment in an implementation.

FIGS. 7A-7E illustrate an exemplary operational scenario of a collaborative prompt object for an LLM integration in an application environment in an implementation.

FIGS. 8A-8E illustrate an exemplary operational scenario of a collaborative prompt object for an LLM integration in an application environment in an implementation.

FIG. 9 illustrates a computing system suitable for implementing the various operational environments, architectures, processes, scenarios, and sequences discussed below with respect to the other Figures.

### DETAILED DESCRIPTION

Various implementations are disclosed herein for integrations of a large language model (LLM) service in the context of an application environment by which multiple users can interact to request, receive, edit, and insert content generated by the LLM service into a shared content item. In an implementation, where the multiple users collaborate on a shared content item (e.g., a document or project canvas) hosted by an application service, an application component enables the multiple users to participate in prompting the LLM service to generate content for the shared item. The application component, a collaborative prompt object, is instantiated in the user interfaces of the computing devices of the multiple users, providing a mechanism for the multiple users to collaborate with respect to generating prompts for the LLM service. When the collaborative prompt object is instantiated, the collaborative prompt object identifies the context of the content item, such as the type of application environment in which the collaborative prompt object has been instantiated. The collaborative prompt object generates an initial prompt for the LLM service including the context and content from content item. The initial prompt tasks the LLM service with generating suggestions for additional content which are to be presented to the user and which, if selected by the user, prompt the LLM service with generating content according to the suggestion. Upon receiving content generated by the LLM service in response to the collaborative prompt, the generated content may be inserted into the underlying, shared document which is then synced by a collaboration framework of the application service to other users.

As various users configure or edit a prompt for the LLM service, the instances of the collaborative prompt object are synced by a relay service which maintains a record of events relating to the collaborative prompt object including the initial, at-launch prompt, the initial response from the LLM service, and subsequent inputs by a user. When an event is relayed from the collaborative prompt object that originated the event to other instances, the originating collaborative prompt object or the relay service may direct the other instances to only display the event or an indication of the event while refraining from duplicating the event's actions with respect to the underlying, shared document. As used herein, the terms “local” and “remote” are relative terms which serve to distinguish between instances operating on different computing devices.

In various implementations of the technology, suggestions prompted by the application component and generated by the LLM service are presented as graphical input devices (e.g., hyperlinks or graphical buttons) which a user can select to have the LLM service generate the suggested content. The suggested content is presented in the interface of the collaborative prompt object where the user or another user with whom the content item is shared can view, edit, delete, or insert the content into the document. A user may also disregard the displayed suggestions or the generated content and enter his or her own request for content.

In various implementations, instances of a collaborative prompt object are displayed in one or more application environments of applications hosted by an application service. In a given instance of an application environment, the collaborative prompt object generates a prompt based on the contextual information drawn from the application environment, such as an identified application environment and content from a collaborative document or canvas hosted by the application or application service. For example, the collaborative prompt object may submit a prompt to an LLM service which tasks the LLM service with generating multiple suggestions for actions to be taken or content to be added based on the contextual information associated with the collaborative document or canvas. The prompt may task the LLM service with generating the suggestions in the form of natural language inputs to be submitted to the LLM service when selected by the user. Upon submitting the prompt to the LLM, the collaborative prompt object receives a reply from the LLM service and configures a response for display in the instances of the collaborative prompt object.

In an implementation, a given instance of collaborative prompt object transmits information relating to an interaction which occurs at the given instance to a relay service which maintains a record of events involving instances of the collaborative prompt object. Information relating to a given event involving an instance of the collaborative prompt object is relayed by the relay service to other instances of the collaborative prompt object. Thus, other instances of the collaborative prompt object are synchronized according to the record of events maintained by the relay service. A response received by a given instance of a collaborative prompt object from the LLM service (e.g., the multiple suggestions) is relayed by the relay service to other instances of the collaborative prompt object for display in the other environments of other users. In various implementations, the relay service operates in connection with the application service or as a subservice of the application service.

In an implementation, an instance of the collaborative prompt object receives user input relating to a displayed response from the LLM service and generates a follow-up prompt for submission to the LLM based on the user input. For example, an instance of the collaborative prompt object may receive a user selection of one of the multiple suggestions generated by the LLM service. (The instance of the collaborative prompt object which generates the follow-up prompt may be the same as or different from the instance which generated the preceding prompt.) Upon receiving the user selection, the instance of the collaborative prompt object generates the follow-up prompt which includes previous interactions and other contextual information. Upon receiving a reply from the LLM service to the follow-up prompt, the instance of the collaborative prompt object configures and displays a response based on the newest reply. The instance of the collaborative prompt object also transmits information relating to the events, (i.e., the user selection, the second prompt, and the LLM response) to the relay service for transmission to other instances. As the interaction between the collaborative prompt object and the LLM are displayed in the user experiences of the application environments, users can not only observe but also participate in the interaction.

In various implementations, instances of a collaborative prompt object may be displayed in different application environments. For example, a collaborative prompt object displayed in a word processing environment may also be displayed in an email. In any of the different application environments, a user can interact with the collaborative prompt object, such as entering a natural language input, responding to a reply from the LLM, editing or modifying content generated by the LLM, and so on.

Transformer models, of which LLMs are a type, are a class of deep learning models used in natural language processing (NLP) based on a neural network architecture which use self-attention mechanisms to process input data and capture contextual relationships between words in a sentence or text passage. Transformer models weigh the importance of different words in a sequence, allowing them to capture long-range dependencies and relationships between words. GPT (Generative Pre-trained Transformer) models, BERT (Bidirectional Encoder Representations from Transformer) models, ERNIE (Enhanced Representation through kNowledge IntEgration) models, T5 (Text-to-Text Transfer Transformer) models, and XLNet models are types of transformer models which have been pretrained on large amounts of text data using a self-supervised learning technique called masked language modeling. Indeed, large language models, such as ChatGPT and its brethren, have been pretrained on an immense amount of data across virtually every domain of the arts and sciences. This pretraining allows the models to learn a rich representation of language that can be fine-tuned for specific NLP tasks, such as text generation, language translation, or sentiment analysis. Moreover, these models have demonstrated emergent capabilities in generating responses which are novel, open-ended, and unpredictable.

In some implementations of the technology disclosed herein, a collaborative prompt object initiates an interaction with an LLM service by generating a prompt based on a user interaction with the application environment, such as opening a document or canvas in the application environment or selecting the collaborative prompt object from a drop-down menu of application components. The application environment may also display a text box overlaying the content item which suggests the user try the collaborative prompt object and, upon the user implementing the suggestion, instantiating the collaborative prompt object and initiating an interaction with the LLM service therein. The collaborative prompt object identifies the context or application environment into which it is instantiated and generates the prompt to include contextual information from or about the application environment along with other information, such as content from the document or canvas, metadata from the document or canvas, user inputs received by the collaborative prompt object, preceding interactions with the LLM, and so on.

In an implementation, the collaborative prompt object tasks the LLM with generating its output in a parse-able format. Upon receiving the output, the collaborative prompt object configures its display based on the output. For example, the output may be configured in eXtensible Markup Language (XML) tags for display. In other scenarios, the output may be configured in a JavaScript Object Notation (JSON) data object or other data structure. In still other scenarios, the output may be configured as source code to be executed by the collaborative prompt object.

Technical effects which may be appreciated from the technology disclosed herein include a prompting system by which a user can receive automatically a number of suggestions for content creation without the user having to identify his or her goal (which may in fact not be clearly understood by the user) and having to devise a query to that effect. Technical effects also include a collaborative prompting system which allows users to participate in soliciting an LLM for content and editing the generated content for a collaboration. The disclosed technology streamlines LLM interactions by providing a collaborative prompt object which automatically generates prompts which incorporate document content and a relay framework which synchronizes the collaborative prompt object across multiple user computing devices, allowing users to provide input for a prompt and to modify generated content. Moreover, the collaborative prompt object streamlines the process of incorporating the generated content into a shared document by interfacing with the application hosting the shared document. In addition, as generated content is synced to remote instances of the collaborative prompt object, the remote instances are directed to display collaborative prompt object events without duplicating actions associated with the events.

Further, in a streamlined interaction with the LLM, the collaborative prompt object determines when to generate a prompt for the LLM and configures the prompt to include the relevant contextual information. The collaborative prompt object then initiates an interaction with the LLM to anticipate the user's needs prior to receiving user input and to offer suggestions to guide the user in accomplishing any of a number of different tasks. The collaborative prompt object tailors its prompts to cause the LLM to generate a reply with minimal latency to minimize negative impacts to the user experience and costs to productivity, for example, by selectively including content from a collaborative document or canvas. The application may also tailor the prompts to more fully leverage the creativity of the LLM while reducing the probability that the LLM will digress or hallucinate (i.e., refer to or imagine things that do not actually exist) which can frustrate the user or further impair productivity.

Other technical advantages may be appreciated from the disclosed technology. Prompts tailored according to the disclosed technology reduce the amount of data traffic between the application service and the LLM for generating useful information for the user. For example, the disclosed technology streamlines the interaction between the user and the application service by keeping the LLM on task and reducing the incidence of erroneous, inappropriate, or off-target replies. The prompts are also tailored to task the LLM with generating parse-able output, thereby reducing the need for post-processing the replies to render the content in a useful form, such as for display in a user interface as a graphical user input device. The disclosed technology also promotes more rapid convergence, that is, reducing the number of interactions with the LLM to generate a desired result.

In addition, the disclosed technology focuses the generative activity of the LLM to improve the performance of the LLM without overwhelming the LLM (e.g., by exceeding the token limit). For example, the disclosed technology balances prompt size (e.g., the number of tokens in the prompt which must be processed by the LLM) with providing sufficient information to generate a useful response. The net of streamlined interaction, more rapid convergence, and optimized prompt sizing is reduced data traffic, faster performance by the LLM, reduced latency, and concomitant improvements to productivity costs and to the user experience.

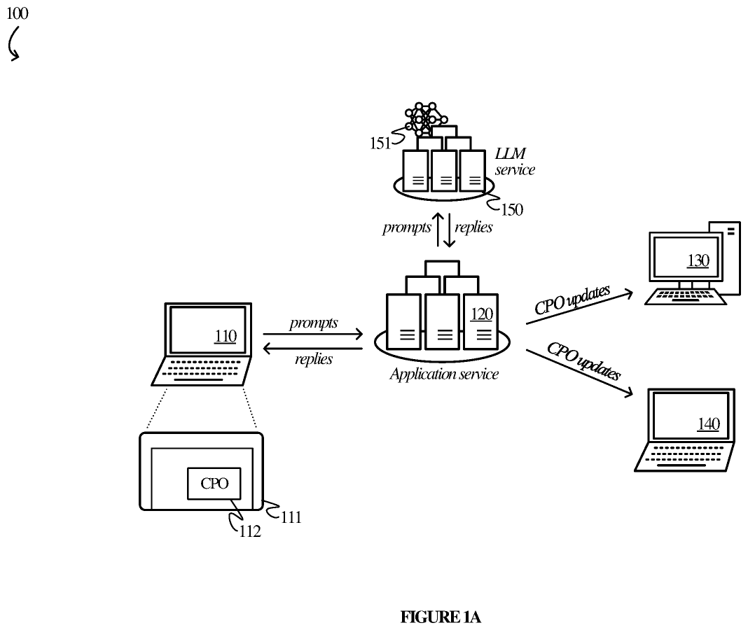

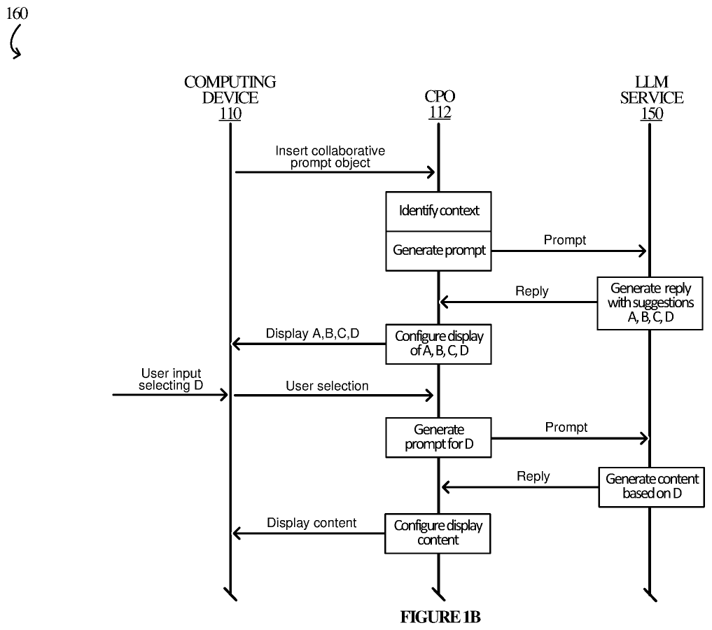

Turning now to the Figures, FIG. 1 illustrates operational environment 100 in an implementation. Operational environment 100 includes application service 120, LLM service 150, and computing devices 110, 130, and 140. Application service 120 hosts an application to endpoints, such as computing devices 110, 130, and 140. Computing devices 110, 130, and 140 execute applications locally that provide a local user experience and that interface with application service 120. The applications running locally with respect to computing devices 110, 130, and 140 may be natively installed and executed applications, browser-based applications, mobile applications, streamed applications, or any other type of application capable of interfacing with application service 120 and providing a user experience, such as user experience 111 displayed on computing device 110. Applications of application service 120 may execute in a stand-alone manner, within the context of another application (e.g., a web browser, a presentation application, or a word processing application), or in some other manner entirely.

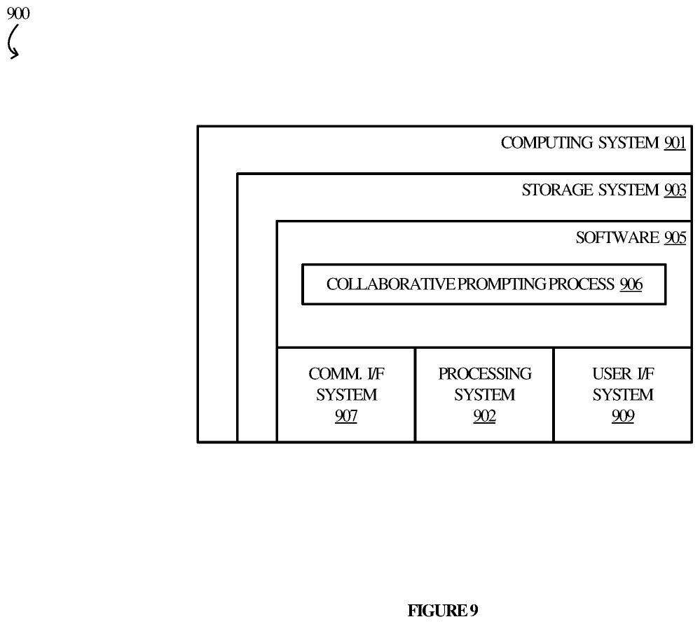

Computing devices 110, 130, and 140 are representative of computing devices, such as laptops or desktop computers, or mobile computing devices, such as tablet computers or cellular phones, of which computing device 901 in FIG. 9 is broadly representative. Computing devices 110, 130, and 140 communicate with application service 120 via one or more internets and intranets, the Internet, wired or wireless networks, local area networks (LANs), wide area networks (WANs), and any other type of network or combination thereof. A user interacts with an application of application service 120 via a user interface of the application displayed on computing device 110, 130, or 140. User experience 111, displayed on computing device 110 and including collaborative prompt object 112, is representative of a user experience of an application environment of an application hosted by application service 120 in an implementation.

Application service 120 is representative of one or more computing services capable of hosting an application, such as a collaboration application, and interfacing with computing devices 110, 130, and 140 and with LLM service 150. Application service 120 may be implemented in software in the context of one or more server computers co-located or distributed across one or more data centers. Collaboration applications (for example, Microsoft Teams) include applications which allow multiple users to simultaneously access and interact with a common content item (e.g., a shared document or project canvas) hosted by application service 120.

LLM service 150 is representative of one or more computing services capable of hosting an LLM computing architecture and communicating with application service 120. LLM service 150 may be implemented in the context of one or more server computers co-located or distributed across one or more data centers. LLM service 150 hosts LLM 151 which is representative of a deep learning AI transformer model, such as BERT, ERNIE, T5, XLNet, or of a generative pretrained transformer (GPT) computing architecture such as GPT-3®, GPT-3.5, ChatGPT®, or GPT-4.

In operation, a user of computing device 110 interacts with application service 120 via user experience 111. User experience 111 includes an application environment of application service 120 and collaborative prompt object 112 which is representative of a local instance of a collaborative prompt object. In an implementation, when the user opens a document in the application environment in user experience 111, collaborative prompt object 112 initiates an interaction with LLM service 150 by generating a prompt including at least a portion of the content of the document. The document content, along with document metadata, provides context in reference to which LLM 151 of LLM service 150 generates a response to the prompt. In some exemplary uses, collaborative prompt object 112 tasks LLM service 150 with generating a summary describing the contents of the document or suggestions of additional content to be added to the document based on the provided context (e.g., document contents and filename).

Continuing the exemplary scenario of operational environment 100, when collaborative prompt object 121 generates a prompt for LLM service 150, computing device 110 transmits the prompt to application service 120 which in turn submits the prompt to LLM service 150. LLM service 150 generates a reply to the prompt that is sent by application service 120 to collaborative prompt object 112. Upon receiving the reply from LLM service 150, collaborative prompt object 112 configures and displays the contents of the reply in the application environment.

As collaborative prompt object 112 interacts with LLM service 150, remote instances of collaborative prompt object 112 executing on computing devices 130 and 140 mirror the interactions in their respective user experiences (not shown). In an implementation, as application service 120 receives user input and prompts from computing device 110 and replies from LLM service 150, application service 120 updates the remote instances of the collaborative prompt object of collaborative prompt object 112 executing on computing devices 130 and 140 with respect to the events thereby allowing users at those devices to observe the events. In various implementations discussed herein, remote users may also engage in interactions with LLM service 150 in their respective instances of the collaborative prompt object, for example, by entering user input to elicit additional content from LLM service 150, by editing a response from LLM service 150 in their respective instances, by inserting a response from LLM service 150 into the underlying document, and so on.

FIG. 1B illustrates operational scenario 160 of operating a system for an LLM integration with an application service as employed by elements of operational scenario 100 in an implementation. In operational scenario 160, computing device 110 inserts a collaborative prompt object 112 in a content environment executing onboard computing device 110. When collaborative prompt object 112 is launched, collaborative prompt object 112 identifies a context of the content environment and generates a prompt for LLM service 150 including the context and existing content in the content environment (if any). The prompt tasks the LLM service with generating suggestions to be presented to a user at computing device 110 relating to content in the content environment, such as information derived from the existing content, supplemental content to be added, or ideas which build on the existing content. The prompt may task LLM service 150 with generating the suggestions in the form of natural language prompts which are to be submitted to an LLM service to generate the suggested content. The prompt may also task LLM service 150 with formatting its output in a parse-able format by which the collaborative prompt object can identify and extract the individual suggestions. The prompt may also task LLM service 150 with generating titles or short phrases which are representative of its suggestions which can be configured by the collaborative prompt object as text labels for input devices corresponding to the suggestions.

Upon submitting the prompt to LLM service 150, LLM service generates a reply including suggestions (labeled in operational scenario 160 as “A,” “B,” “C,” and “D”) based on the prompt and returns the reply to collaborative prompt object 112. Collaborative prompt object 112 configures a display of the suggestions including graphical input devices corresponding to each of the four suggestions. Computing device 110 displays the graphical input devices in the content environment and receives input from the user indicating a selection of suggestion D.

Upon receiving the user selection of suggestion D, collaborative prompt object 112 configures another prompt based on suggestion D. To configure the prompt, collaborative prompt object 112 includes the natural language prompt content generated by LLM service 150 for suggestion D. Collaborative prompt object 112 submits the natural language prompt for suggestion D to LLM service 150 and receives content generated in accordance with the suggestion. Collaborative prompt object 112 configures a display of the generated content for display in the content environment of computing device 110.

Subsequent to displaying the generated content based on suggestion D, collaborative prompt object 112 may receive subsequent user input relating to the content, such as a modification of the content or a command to insert the content into the content item displayed in the content environment. Collaborative prompt object 112 may also receive a natural language input relating to the generated content (e.g., “make it shorter”) or input wholly unrelated to the generated content. Based on subsequent inputs from the user, collaborative prompt object 112 generates new prompts for submission to LLM service 150, including previous inputs from the user and replies from LLM service 150 as well as the identified context of the content environment.

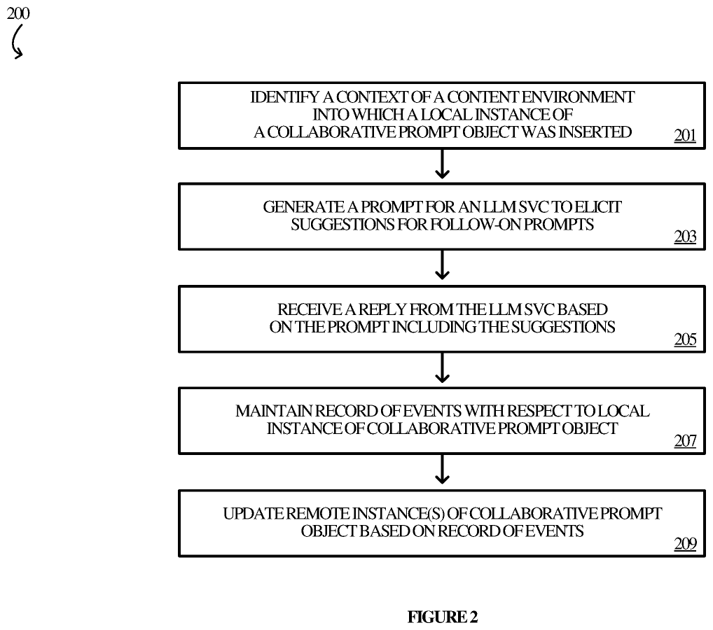

FIG. 2 illustrates a method of operating a relay framework for an LLM integration with an application service in an implementation, herein referred to as process 200. Process 200 may be implemented in program instructions in the context of any of the software applications, modules, components, or other such elements of one or more computing devices. The program instructions direct the computing device(s) to operate as follows, referred to in the singular for the sake of clarity.

A computing device inserts into a content environment a local instance of a collaborative prompt object. In an implementation, the user selects the collaborative prompt object from a drop-down menu of application components or plugins which causes the content environment to insert or display the collaborative prompt object, such as a floating window or pane inserted into the content display in the content environment. The content environment may be, in some implementations, a word processing application displaying a document or a project canvas or page of a collaboration application. The local instance includes a user interface by which to display messages (e.g., suggestions) from the collaborative prompt object or content environment to the user, responses generated by an LLM service, user input, and so on. In some scenarios, as with shared content items, remote instances of the collaborative prompt object are displayed in the user interfaces of other users (i.e., collaborators).

In exemplary scenario, an application service hosts an application and displays a user interface in an application environment on a user computing device remote from the application service. The application service is operatively coupled to a relay framework which interfaces with an LLM service in relation to a content item, such as a document or canvas, of the application service. In an implementation, the application service inserts a local instance of a collaborative prompt object into a document hosted by the application service.

When the collaborative prompt object is launched in the content environment, the collaborative prompt object identifies the context of the content environment (step 201). The context of content environment can include the application or application environment and the document, file, project page, etc. into which the component was inserted.

In some scenarios, the collaborative prompt object may be launched in a productivity application environment, such as a word processing application, a spreadsheet application, a collaboration application, or a presentation application. For example, when the collaborative prompt object is launched in a word processing application, the collaborative prompt object identifies the context as a word processing environment and a document opened in the word processing environment. Other contexts can include the particular document, page, sheet, workbook, file, or other content item of a collaboration application, a spreadsheet application, a presentation application, an email application, a chat application, and so on. The identified context is indicated by the collaborative prompt object in prompts to an LLM service to provide context relating to the content item. For example, content generated by the LLM service for an email may differ in style, language, and length from content generated for a word processing document.

The collaborative prompt object generates a prompt for an LLM service to elicit suggestions for follow-on prompts (step 203). In an implementation, the prompt configured by the collaborative prompt object includes the context or contextual information relating to or gathered from the content environment. The prompt also includes content from the content environment. For example, if the content environment is a document of a word processing application, the collaborative prompt object will include text or other content from the document the prompt. If the content environment is a project canvas in a collaboration application, the collaborative prompt object will include input from various users from the project canvas.

In an implementation, the collaborative prompt object tasks the LLM service in the prompt with generating one or more suggestions which will be presented to the user based on the included context and content. The suggestions may include suggestions for additional content to be generated by the LLM service for the user, such as a description of the existing content, supplemental content to be added to the existing content, suggestions of additional resources relating to the existing content, a checklist or bullet-point list summarizing the existing content, and so on.

The collaborative prompt object receives a reply from the LLM service based on the prompt including the one or more suggestions generated by the LLM service (step 205). In an implementation, the collaborative prompt object receives suggestions for content which is to be generated by the LLM service with respect to the content item (e.g., document, project canvas, email, spreadsheet, presentation, etc.). The prompt may task the LLM service with formatting its output in a parse-able format (e.g., enclosed in semantic tags or within a JSON data object) and the collaborative prompt object extracts the individual suggestions from the output according to the parse-able format. The collaborative prompt object may then display a graphical button or hyperlink for each suggestion by which the user can select a suggestion to implement. In an implementation, the collaborative prompt object further tasks the LLM service with generating a short phrase representative of each suggestion along with generating the suggestions and formats the short phrases in its output by which the collaborative prompt object to identify and extract the short phrases (e.g., <button label> and </button label>). The collaborative prompt object extracts the short phrases and configures the graphical input devices to display the short phrases. In this way, the user is presented in the interface of the collaborative prompt object with a number of suggestions for content to be generated by the LLM service in relation to the existing content without the user having to request it.

As the local instance of the collaborative prompt object interacts with the LLM service, the relay framework maintains a record of events with respect to the local instance of the collaborative prompt object (step 207). In an implementation, the relay framework receives and stores information relating to the local instance of the collaborative prompt object, such as user input, prompts submitted to the LLM service, and replies from the LLM service. In some scenarios, the relay framework receives and stores the events as it relays prompts and replies between the LLM service and the local instance of the collaborative prompt object including the initial, at-launch prompt and the subsequent reply including the one or more suggestions from the LLM service.

As the relay framework maintains the record of events with respect to the collaborative prompt object, the relay framework updates remote instances of the collaborative prompt object based on the record of events (step 209). In an implementation, the relay framework sends information relating to the record of events associated with the local instance of the collaborative prompt object to remote instances for display as they are happening at the local instance. The remote instances receive the information of events relating to the local instance and display the information in the respective user experiences such that a remote user can view an interaction happening at the local instance as if it was occurring at the remote instance.

In various implementations, as a remote user is viewing events at the local instance, the remote user can participate in an event via the remote instance of the collaborative prompt object. For example, as content generated by the LLM service is displayed in the remote instance, the remote user may choose to edit or modify the content prior to inserting the content into the underlying document. In other scenarios, the remote user may submit a follow-on query relating to the content for submission to LLM service.

In various implementations, remote instances of the collaborative prompt object may be displayed in an application environment which is different from that of the local instance. For example, a local instance of a collaborative prompt object displayed in a word processing application environment may have a remote counterpart displayed in a presentation application environment or an email application environment. In scenarios where the local and remote instances are displayed with respect to a shared document or the same type of application environment, the relay framework may direct the remote instance to display an action performed at the local instance without performing the actions, thereby avoiding the remote instance duplicating the action.

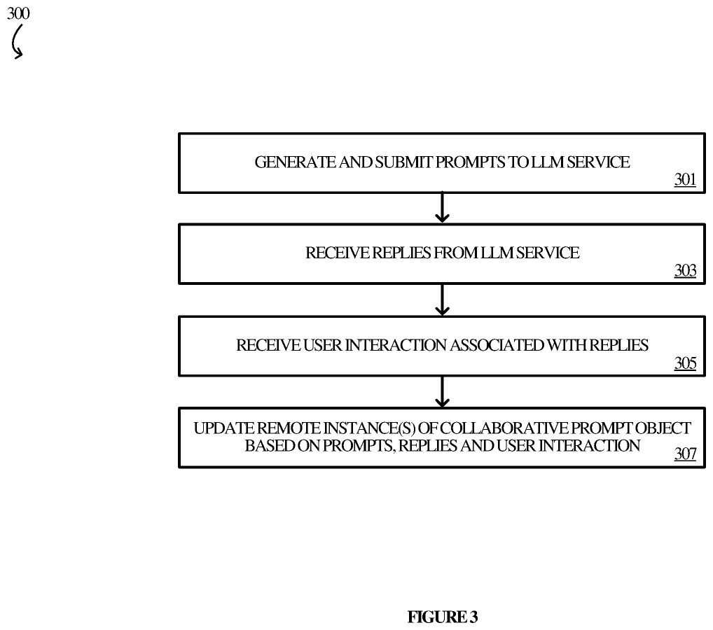

FIG. 3 illustrates a method of operating a collaborative prompt object of an LLM integration with an application service in an implementation, herein referred to as process 300. Process 300 may be implemented in program instructions in the context of any of the software applications, modules, components, or other such elements of one or more computing devices. The program instructions direct the computing device(s) to operate as follows, referred to in the singular for the sake of clarity.

A local instance of a collaborative prompt object is displayed in a user experience of an application service. In the user experience, the local instance of the collaborative prompt object interacts with an LLM service in relation to a document hosted by the application service. The document is shared with other remote users via a collaboration service of the application service which allows multiple users to simultaneously act on the document.

In an implementation, the local instance of the collaborative prompt object is displayed in the local user experience when the local user opens the document or when the local user instantiates the local instance by user input, such as selecting the collaborative prompt object from a drop-down menu of available application components.

The instance of the collaborative prompt object in the local user experience generates and submits prompts to an LLM service (step 301). In an implementation, when a local instance of the collaborative prompt object is displayed in the user experience, the collaborative prompt object automatically generates a prompt based on the contextual information associated with the underlying (shared) document. Contextual information can include a portion or all of the content of the document, a document title, a filename, or other information relating to the document. The prompt tasks the LLM service with generating content relating to the document. In some scenarios, the collaborative prompt object tasks the LLM service with generating one to three sentences which describe the document or its contents. In other scenarios, the LLM service is tasked with generating one or more suggestions to be presented to the user of content to be generated by the LLM service relating to the document.

Upon submitting prompts to the LLM service, the local instance of the collaborative prompt object receives replies from the LLM service (step 303). In an implementation, the local instance of the collaborative prompt object interacts with the LLM service via an application programming interface (API) of the LLM service. The local instance receives replies based on the prompts and configures a response for display in the user interface of the local instance in the application environment. The prompts may task the LLM service with configuring its output in a parse-able format, such as in XML tags or in a JSON data object. For example, the prompts may task the LLM service with configuring a set of suggestions in its output as user interface objects, such as graphical buttons, which the local instance of collaborative prompt object can implement directly in the user interface of the local instance.

The local instance of the collaborative prompt object receives user interaction associated with the replies (step 305). In an implementation, the local instance of collaborative prompt object displays content generated by the LLM service such that a user can edit the content, e.g., add, modify, or delete portions of the content. In some implementations, the local instance displays a reply in the form of graphical user input devices (e.g., buttons) by which to receive a user input to select an option presented in the reply. In other scenarios, the user interaction may cause the local instance of the collaborative prompt object to insert the content (as received from the LLM service or after the user has edited it) into the underlying document. In still other scenarios, the user may input a query or request relating to the content for which the local instance generates a follow-on prompt for the LLM service.

As it interacts with the LLM service, the local instance of the collaborative prompt object updates remote instances of the collaborative prompt object based on the prompts, replies, and user interaction associated with the local instance (step 307). In an implementation, the local instance relays information relating to its events or interactions with the LLM service to remote instances of the collaborative prompt object which are displayed on remote computing devices for other users or collaborators. The local instance may transmit information relating to the interactions to the remote instances via a relay framework which operates in conjunction with the application service hosting the underlying document.

In some implementations, a remote instance of the collaborative prompt object may be displayed in application environments that are different from the application environment of the local instance. For example, while the local instance of the collaborative prompt object may be displayed in a word processing application environment, a remote instance of the collaborative prompt object may be displayed in an email environment.

In an implementation where the remote instances of the collaborative prompt object are displayed with respect to a shared document, as the local instance relays event information, the local instance or the relay framework may direct the remote instances to display the interactions but to refrain from performing the actions being displayed. For example, if the local user causes the local instance of the collaborative prompt object to insert content into the underlying document, the remote instances are directed to display the interaction but without also performing it, i.e., display the insertion of the content into the underlying document but without duplicating the act of insertion.

Referring once again to FIG. 1, operational environment 100 includes a brief example of processes 200 and 300 as employed by elements of operational environment 100. In an exemplary implementation, a user at computing device 110 interacts with an application hosted by application service 120, such as opening a document hosted by the application. Application service 120 inserts a local instance of the collaborative prompt object, i.e., collaborative prompt object 112, in the application environment displayed in user experience 111. As collaborative prompt object 112 receives user input, generates prompts for LLM service 150, and receives replies to the prompts from LLM service 150, application service 120 maintains a record of events with respect to the collaborative prompt object. Using the record of events, application service 120 updates one or more remote instances of the collaborative prompt object.

In various implementations, a relay framework (not shown) of application service 120 relays communication between collaborative prompt object 112 and LLM service 150, application service 120, and remote instances of the collaborative prompt object (such as those executing on computing devices 130 and 140). The relay framework also maintains a record of events with respect to the collaborative prompt object and synchronizes the instances of collaborative prompt object 112 based on the record of events.

In an implementation of operational environment 100, collaborative prompt object 112 automatically generates and submits prompts to LLM service 150 in response to events such as a user interaction with application service 120 (e.g., opening a document hosted by application service 120). In generating a prompt for LLM service 150, collaborative prompt object 112 identifies and includes contextual information of the application environment in the prompts which provides a basis or direction for LLM 151 of LLM service 150 to generate its reply.

Upon receiving a reply to a prompt from LLM service 150, collaborative prompt object 112 configures a display of the reply in the user interface of collaborative prompt object 112. The reply or configured display of the reply is relayed by the relay framework for display in other instances of the collaborative prompt object. In the various instances, a user may submit input at the user's local instance which relates to the reply from LLM service 150, such as editing content of the reply, causing the user's local instance to insert the content into the underlying document, asking a follow-up question relating to the content, deleting the content and inputting a new, unrelated prompt, and so on.

As events (e.g., prompts, replies, and user interaction) occur with respect to the collaborative prompt object, collaborative prompt object 112 updates the remote instances of the collaborative prompt object executing on computing devices 130 and 140. In updating the remote instances of the collaborative prompt object, collaborative prompt object 112 may include a directive to refrain from performing the action indicated in the update when the events relate to a shared document. For example, collaborative prompt object 112 may display an action by the local user to insert content in the underlying, shared document, but when transmitting the event to the remote instances, collaborative prompt object 112 disables the remote instances with respect to performing the displayed action.

In some implementations, collaborative prompt object 112 updates remote instances of the collaborative prompt object via a relay framework. The relay framework maintains a record of events relating to the collaborative prompt object, such as events occurring at collaborative prompt object 112, and synchronizes the remote instances according to the record of events.

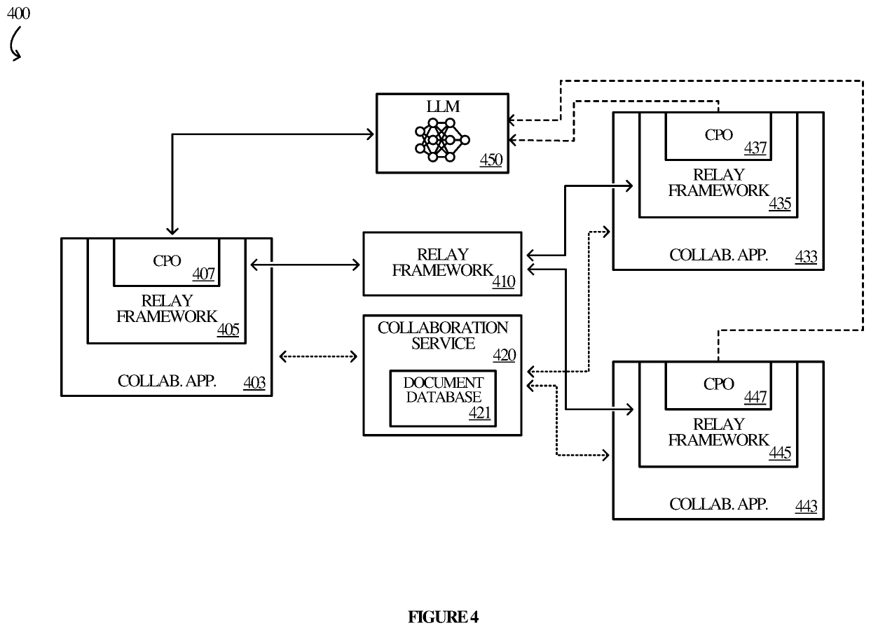

Turning now to FIG. 4, FIG. 4 illustrates system architecture 400 including collaboration service 420 which hosts interactions between collaboration applications 403, 433, and 443. Collaboration applications 403, 433, and 443 execute on computing devices remote from collaboration service 420. Collaboration service 420 includes document database 421 which stores data relating to a shared document hosted in collaboration applications 403, 433, and 443.

Collaboration applications 403, 433, and 443 are operatively coupled with relay frameworks 405, 435, and 445, respectively. Interaction between relay frameworks 405, 435, and 445 is hosted by relay framework 410 which operates independently from collaboration service 420. In some implementations, relay framework 410 and collaboration service 420 are subservices of an application service hosting the shared document. Each of relay frameworks 405, 435, and 445 hosts instances of a collaborative prompt object referred to herein as collaborative prompt objects 407, 437, and 447, respectively. Each of collaborative prompt objects 407, 437, and 447 can interact with LLM service 450 (e.g., generate prompts for and receive replies from) as well as receive user input. Relay framework 410 maintains a record of events associated with the collaborative prompt object of collaborative prompt objects 407, 437, and 447 and synchronizes the instances based on the record of events. Relay frameworks 405, 435, and 445 may interact with collaboration applications 403, 433, and 443, respectively, such as identifying contextual information relating to a shared document hosted by collaboration applications 403, 433, and 443 and inserting content from collaborative prompt objects 407, 437, and 447, such as content generated by LLM service 450 or user input received by collaborative prompt object 407, 437, or 447.

Collaboration service 420 supports collaborative activities between multiple users with respect to a shared document hosted in collaboration applications 403, 433, and 443, such as a shared productivity document (e.g., word processing document, spreadsheet document, presentation document, etc.) or project management document or canvas. Collaboration applications 403, 433, and 443 may also include other types of applications, such as email applications, which are capable of interacting with relay framework components and collaborative prompt objects.

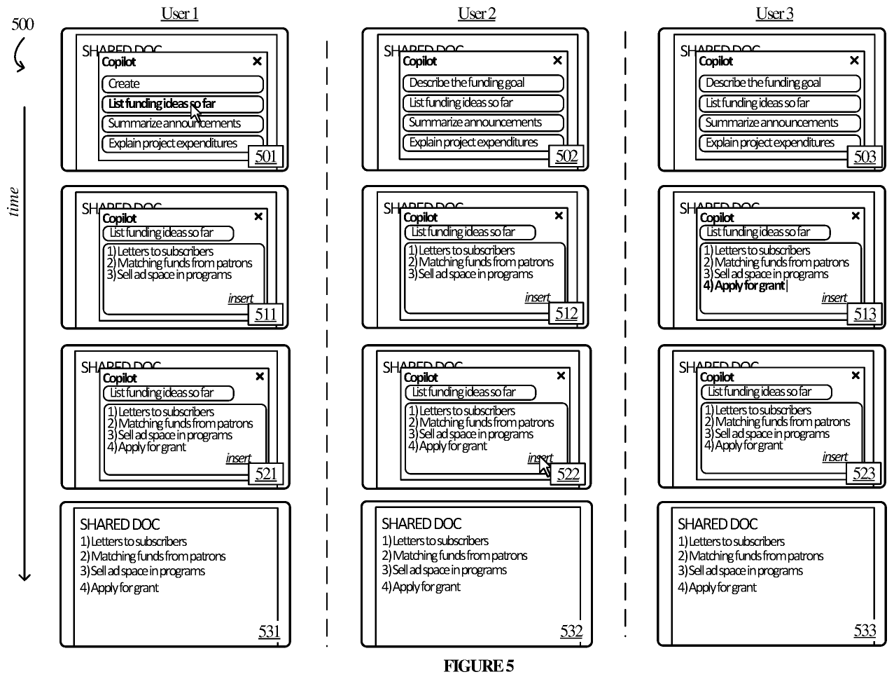

Turning now to FIG. 5, FIG. 5 illustrates operational scenario 500 of a collaborative prompt object supporting LLM integration in an application environment in an implementation of the technology disclosed herein. In operational scenario 500, a shared document is displayed in the user experiences of three users (“User 1,” “User 2,” and “User 3”) remote from one another. The user experiences in operational scenario 500 also display instances of a collaborative prompt object (“Copilot”) as graphical user interfaces overlaying the underlying, shared document for each user. For example, user experiences 501, 511, 521 and 531 of User 1 are representative of an application environment of application 403 and collaborative prompt object 407 of FIG. 4. Similarly, user experiences 502, 512, 522, and 532 of User 2 are representative of an application environment of collaboration application 433 and collaborative prompt object 437 of FIG. 4, and those of User 3, of collaboration application 443 and collaborative prompt object 447.

The rows of user experiences in operational scenario 500 represent a sequence of events as the instances of the collaborative prompt object interact with an LLM service.

Prior to the onset of operational scenario 500, a prompt from an instance of a collaborative prompt object (e.g., from collaborative prompt object 407, 437, or 447) tasked the LLM service with generating multiple suggestions to be presented to the user with respect to actions to be taken on or performed with respect to the shared document. The instances of the collaborative prompt object displayed in user experiences 501, 502, and 503 display graphical input devices for the suggestions generated by the LLM service.

Continuing operational scenario 500, in user experience 501, User 1 selects the second suggestion by clicking the respective graphical button. In an implementation, the instances are synchronized by a relay framework which maintains a record of events with respect to the collaborative prompt object and updates the instances of the collaborative prompt object according to the record of events. In user experiences 511, 512, and 513, each of the instances of the collaborative prompt object display the user input received from User 1 in user experience 501 and content from a reply generated by the LLM service in response to the user input. The content includes a list of three items based on the contextual information provided in the prompt, i.e., based on content from the underlying, shared document. As displayed in the instances of the collaborative prompt object, any of the users viewing the collaborative prompt object can participate in the interaction displayed in his/her respective instance.

In user experience 513, User 3 edits the content to add an item to the list. Upon the local instance of User 3 submitting the edit to the relay framework, user experiences 521, 522, and 523 are synchronized to display the edited content. User experience 522 receives user input indicating that the updated content is to be inserted in the underlying document. In an implementation, the local instance of the collaborative prompt object of User 2 interacts with the application service of the shared document to transmit the content for insertion into the document. As illustrated in user experiences 531, 532, and 533, the shared document is updated to display the content inserted from the collaborative prompt object.

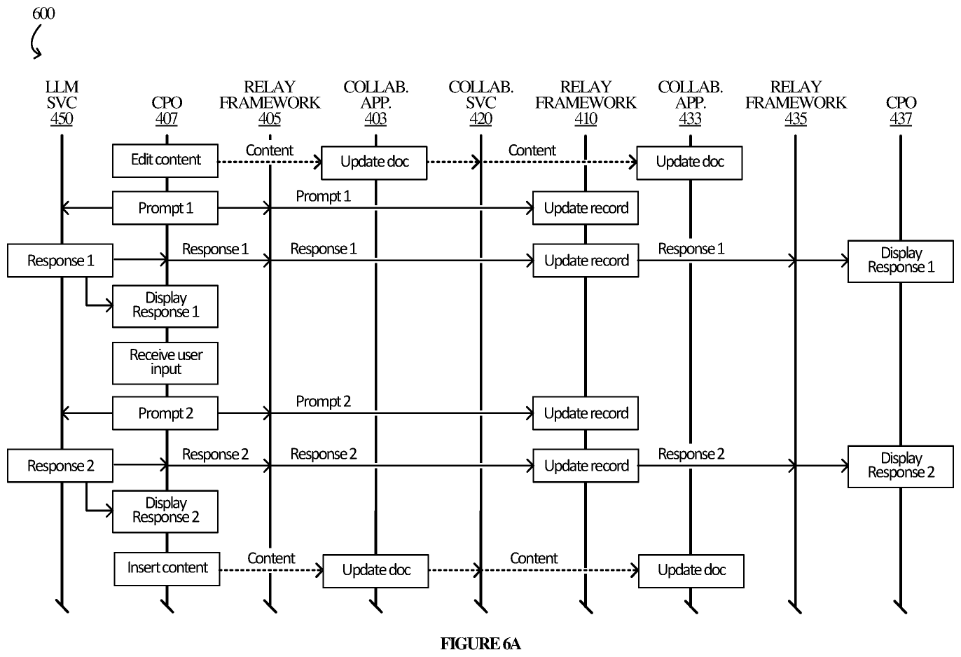

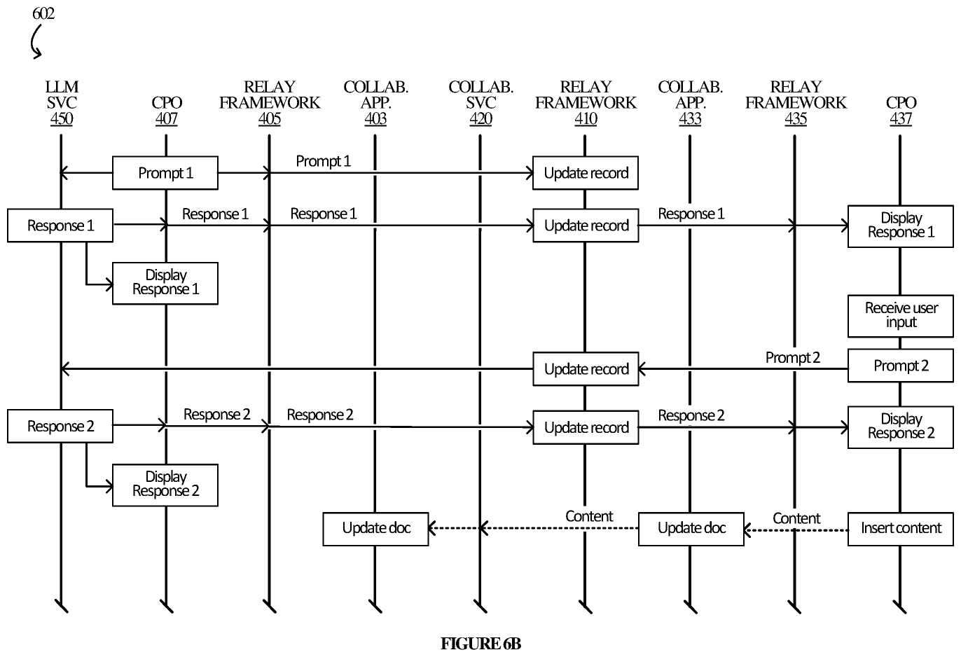

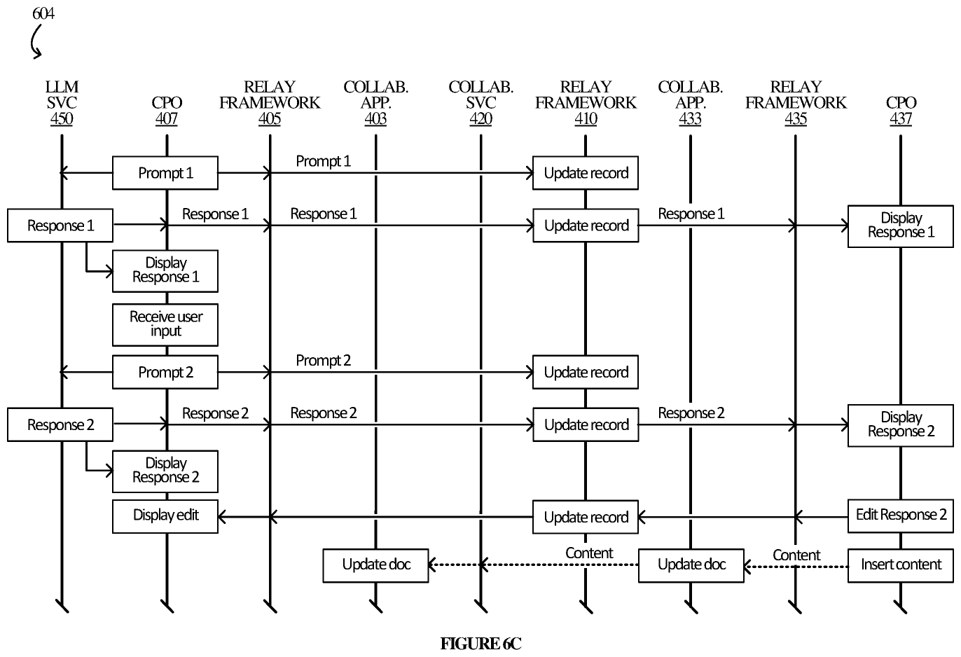

FIGS. 6A-6C illustrate operational scenarios of a collaborative prompt object for LLM integration in an application environment, referring to elements of system architecture 400 of FIG. 4 in an implementation. In operational scenario 600 of FIG. 6A, a user edits content in a shared document hosted by collaboration service 403. As the shared document is edited, collaboration service 420 syncs the shared document to the other instances of the document, such as to collaboration service 433.

Next, collaborative prompt object 407 (i.e., an instance of the collaborative prompt object) generates a prompt (“Prompt 1”) for LLM service 450. Prompt 1 includes contextual information from the shared document for LLM service 450 to generate its response. Collaborative prompt object 407 transmits Prompt 1 to LLM service 450 and to relay framework 405 which in turn relays the event (i.e., the prompt) to relay framework 410. Relay framework 410 records the event in association with the collaborative prompt object.

LLM service 450 generates a response (“Response 1”) to Prompt 1 which is received and displayed by collaborative prompt object 407. From collaborative prompt object 407, relay framework 405 transmits Response 1 to relay framework 410 which records the event and sends the event to relay framework 435. Collaborative prompt object 437 associated with relay framework 435 is updated to display Response 1, thereby mirroring the user interface of collaborative prompt object 407.

Subsequent to receiving Response 1, collaborative prompt object 407 receives user input relating to Response 1. For example, LLM service 450 may generate suggestions for content to be added to the shared document, and the user input may be a selection of a suggestion. Based on the user input, collaborative prompt object 407 generates Prompt 2 and submits Prompt 2 to LLM service 450. Relay framework 405 sends event information relating to Prompt 2 to relay framework 410 for record-keeping.

LLM service 450 generates Response 2 based on Prompt 2 which is received and displayed by collaborative prompt object 407. Response 2 is also transmitted by relay framework 405 to relay framework 410 which updates relay framework 435 and collaborative prompt object 437. Collaborative prompt object 407 receives user input indicating the content of Response 2 is to be inserted into the shared document. Collaborative prompt object 407 transmits the content to collaboration application 403 which updates the local instance of the shared document and transmits the update to collaboration service 420. Collaboration service 420 in turn updates remote instances of the shared document, such as the instance hosted by collaboration application 433.

Operational scenario 602 of FIG. 6B begins in a similar manner as operational scenario 600 but illustrates user interaction at a remote instance of the collaborative prompt object. In operational scenario 602, collaborative prompt object 407 generates a prompt (“Prompt 1”) for LLM service 450. Prompt 1 includes contextual information from the shared document for the response from LLM service 450. Collaborative prompt object 407 transmits Prompt 1 to LLM service 430 and to relay framework 405 which in turn relays the event (i.e., the prompt) to relay framework 410. Relay framework 410 records the event.

LLM service 450 generates a response (“Response 1”) to Prompt 1 which is received and displayed by collaborative prompt object 407. From collaborative prompt object 407, relay framework 405 transmits Response 1 to relay framework 410 which records the event and synchronizes relay framework 435. Collaborative prompt object 437 is updated to display Response 1.

Upon displaying Response 1, collaborative prompt object 437 receives user input relating to Response 1. For example, LLM service 450 may generate suggestions in Response 1 for content to be added to the shared document, and the user input may be a selection of a suggestion. Based on the user input, collaborative prompt object 437 generates Prompt 2 and submits Prompt 2 to LLM service 450. In an implementation, relay framework 435 sends event information relating to Prompt 2 to relay framework 410.

LLM service 450 generates Response 2 based on Prompt 2 which is received and displayed by collaborative prompt object 437. Response 2 is also transmitted by relay framework 435 to relay framework 410. Relay framework 410 transmits Response 2 to relay framework 405 for display by collaborative prompt object 407.

Next, collaborative prompt object 437 receives user input indicating the content of Response 2 is to be inserted into the shared document. Collaborative prompt object 437 transmits the content to collaboration application 433 which updates the local instance of the shared document and transmits the update to collaboration service 420. Collaboration service 420 in turn updates remote instances of the shared document, such as the instance hosted by collaboration application 403.

Operational scenario 604 of FIG. 6C begins in a similar manner as operational scenario 600 with user interaction at both local and remote instances of the collaborative prompt object. In operational scenario 604, subsequent to receiving Response 1 in response to Prompt 1, collaborative prompt object 407 generates Prompt 2 based on user input received in response to Response 1 and submits Prompt 2 to LLM service 450. In an implementation, relay framework 410 also receives event information relating to Prompt 2. LLM service 450 generates Response 2 based on Prompt 2 which is transmitted for display at collaborative prompt objects 407 and 437 and recorded by relay framework 410.

In the display of Response 2 at collaborative prompt object 437, collaborative prompt object 437 receives user input which includes one or more edits of Response 2. For example, the user may add to the content, modify the content, or delete the content of Response 2. As collaborative prompt object 437 receives the user input editing Response 2, the editing event is transmitted to relay framework 410 which records the event and synchronizes the collaborative prompt object 407. As relay framework 410 synchronizes relay framework 405 with respect to the editing event, relay framework 410 may include a directive to relay framework 405 to display the editing event without also performing the actions of the editing event.

Next, collaborative prompt object 437 receives user input including a command to insert the Response 2 as edited at collaborative prompt object 407 into the shared document. Collaborative prompt object 437 transmits to collaboration application 433 the content for insertion into the document. Collaboration application 433 updates the local instance of the shared document and transmits the to-be-inserted content to collaboration service 420 which synchronizes other instances of the shared document, such as the instance hosted by application 403.

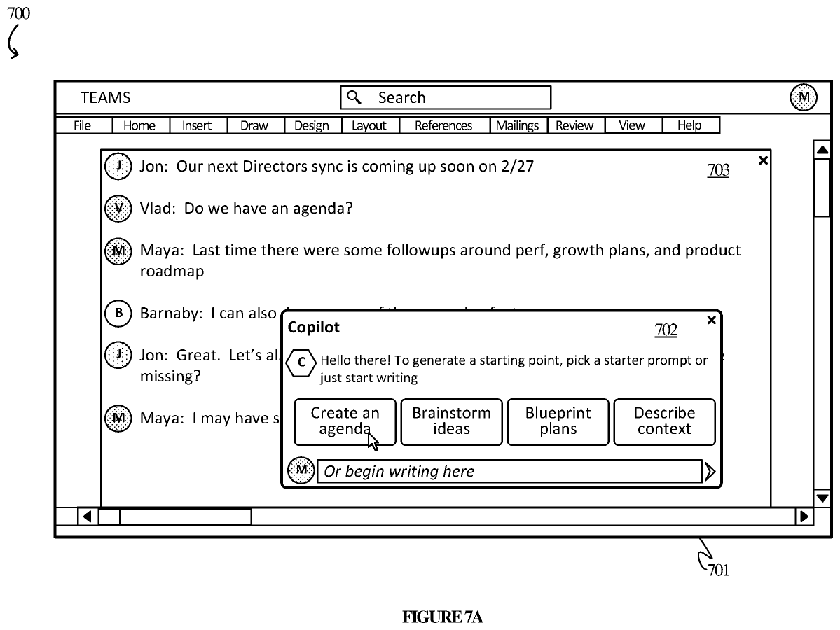

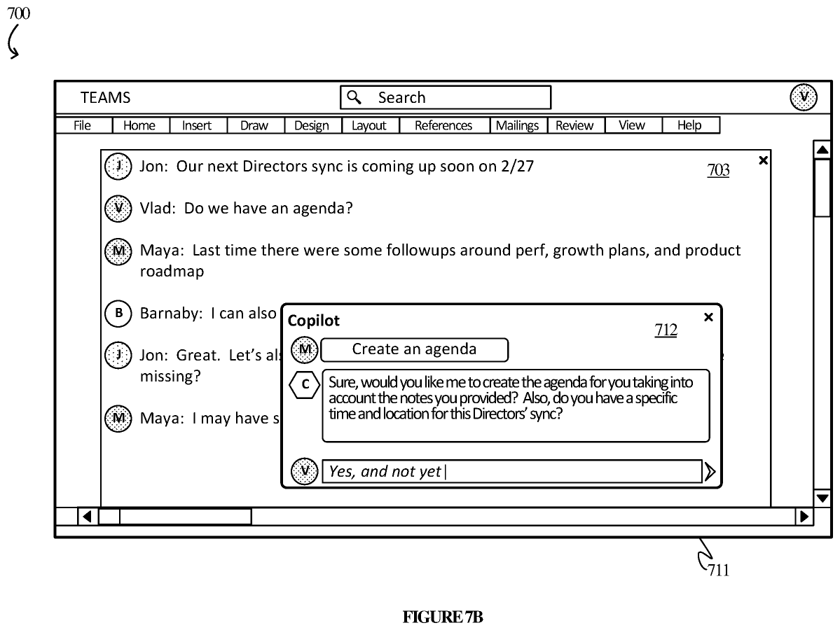

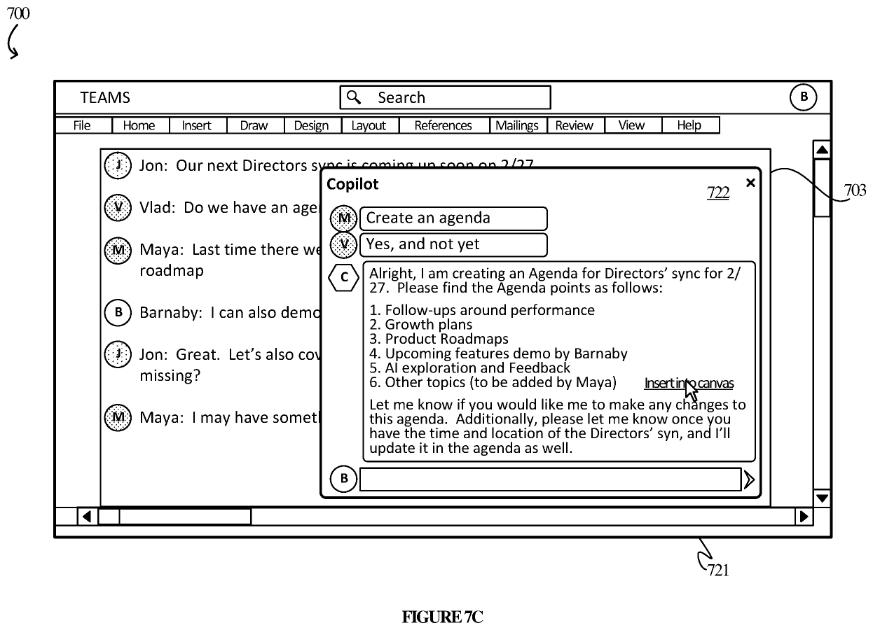

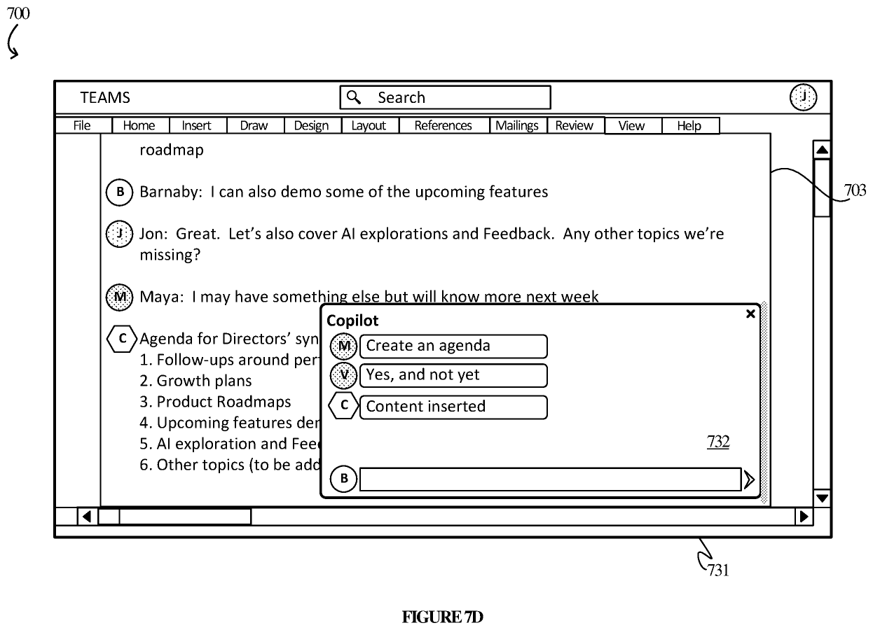

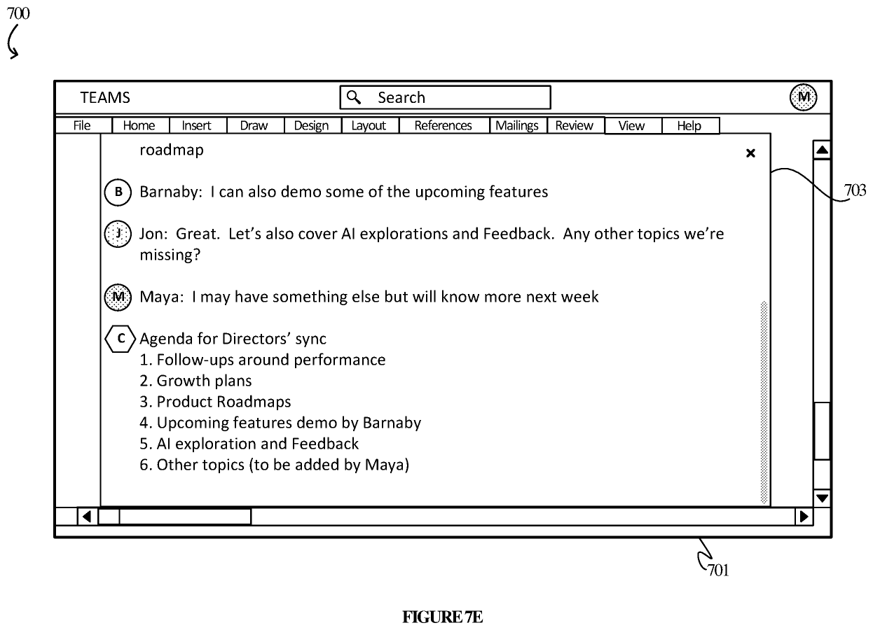

FIGS. 7A-7D illustrate operational scenario 700 of a collaborative prompt object for LLM integration in a collaboration application environment in an implementation. In operational scenario 700 of FIG. 7A, a collaboration amongst multiple users hosted by a collaboration application is displayed in user experience 701 of one user, “Maya.” The collaboration includes shared project canvas 703 on which the multiple users can each contribute content. In FIG. 7A, instance 702 of a collaborative prompt object (entitled “Copilot”) is surfaced in user experience 701.

Prior to the onset of events in operational scenario 700, an LLM service was tasked with generating suggestions for additional content for canvas 703. The prompt submitted to the LLM service included content from canvas 703. Instance 702 displays a response configured from the reply from an LLM service based on the prompt. In an implementation, the prompt also tasked the LLM service with formatting its output as graphical user input objects, such as graphical buttons, which are displayed in instance 702 of the collaborative prompt object. Instance 702 also displays a text box for receiving user input. In FIG. 7A, instance 702 of the collaborative prompt object receives a user input which selects a graphical button to “Create an agenda” from the reply from the LLM service.

Continuing operational scenario 700 in FIG. 7B, user experience 711 for another of the collaborators, “Vlad,” is illustrated with instance 712 of the collaborative prompt object overlaying canvas 703. Instance 712 is updated to show the response received from the user input submitted in instance 702 in FIG. 7A. In instance 712, content generated by the LLM service is displayed along with user input from the user Vlad which responds to the queries in the LLM's response.

In FIG. 7C, user experience 721 of a third collaborator, “Barnaby,” is illustrated with instance 722 of the collaborative prompt object. In instance 722, a reply from the LLM service is displayed based on a prompt generated including the contents of canvas 703 and the preceding events (i.e., LLM interactions) for context. The response from the LLM service includes the agenda generated in response to the prompt along with suggestions for additional information to be provided by a user. In addition, instance 722 displays a hyperlink for inserting the generated content into canvas 703. Continuing operational scenario 700, user Barnaby clicks the hyperlink to insert the generated content into canvas 703. Although not illustrated, any of the other users viewing an instance of the collaborative prompt object may see could amend the content in his or her respective instance of the collaborative prompt object prior to insertion.

In FIG. 7D, user experience 731 of a fourth user, “Jon,” is illustrated with instance 732 of the collaborative prompt object. Instance 732 displays events associated with the collaborative prompt object along with an indication of which user or entity instigated the event. In an implementation, a relay framework maintains a record of events associated with the collaborative prompt object synchronizes instances 702, 712, 722, and 732 of the collaborative prompt object according to the record. Instance 732 and other instances of the collaborative prompt object which did not originate the insertion event are synchronized to show the insertion event. In synchronizing the instances, the originating instance of an event or the relay framework may direct the other non-originating instances to refrain from also performing the event. As illustrated, instance 732 receives an indication of the insertion event from the relay framework and displays the event but refrains per the directive from also performing the event, i.e., inserting the content into canvas 703. In some implementations, the directive to refrain from duplicating an action of an event is issued by the relay framework to the non-originating instances of the collaborative prompt object when the event relates to an underlying, shared document or canvas which is synchronized by a separate synchronization or collaboration framework. As illustrated in project canvas 703 in FIG. 7D, the change to project canvas 703 (i.e., the content insertion) has been synchronized by a collaboration framework (not shown) of the application service hosting canvas 703 to display the updated content.

In FIG. 7E, user experience 701 of user “Mara” illustrates project canvas 703 after the insertion of the generated content. In an implementation, the application hosting canvas 703 receives the generated content from instance 722 of the collaborative prompt object and inserts the content into the document. The collaboration framework of the application service synchronizes remote instances of canvas 703 on remote computing devices of the other users.

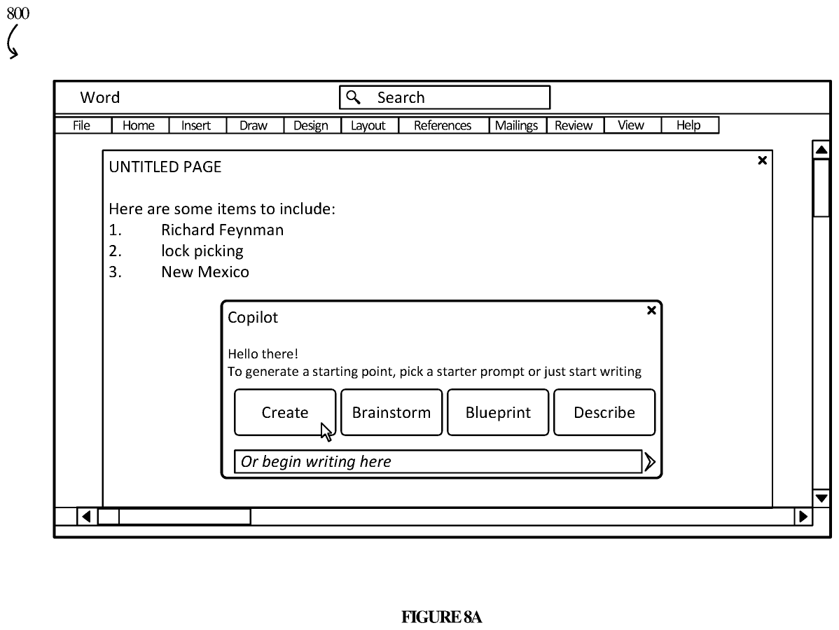

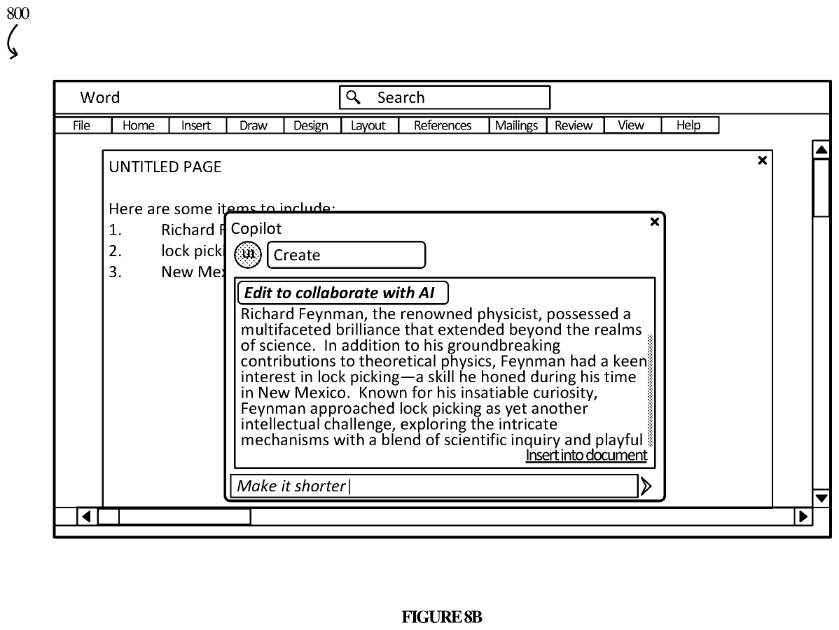

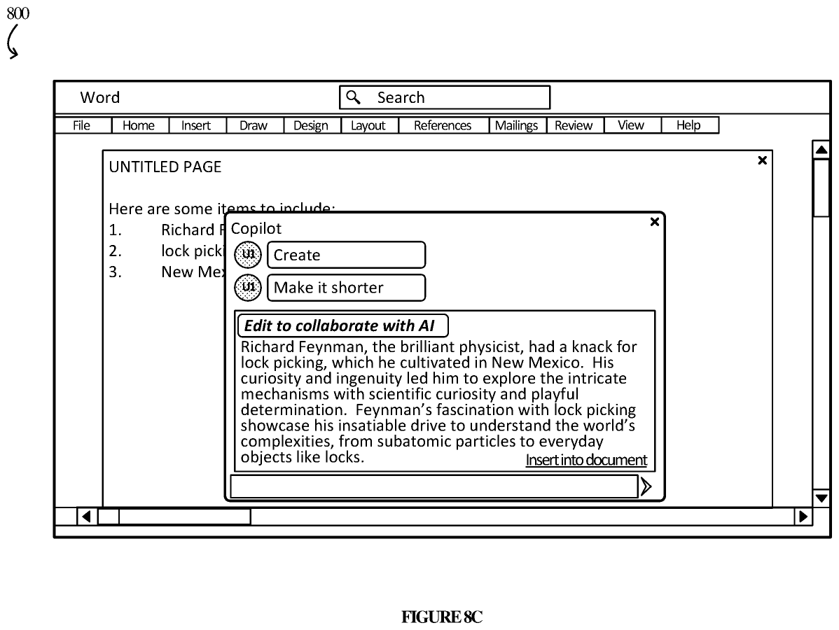

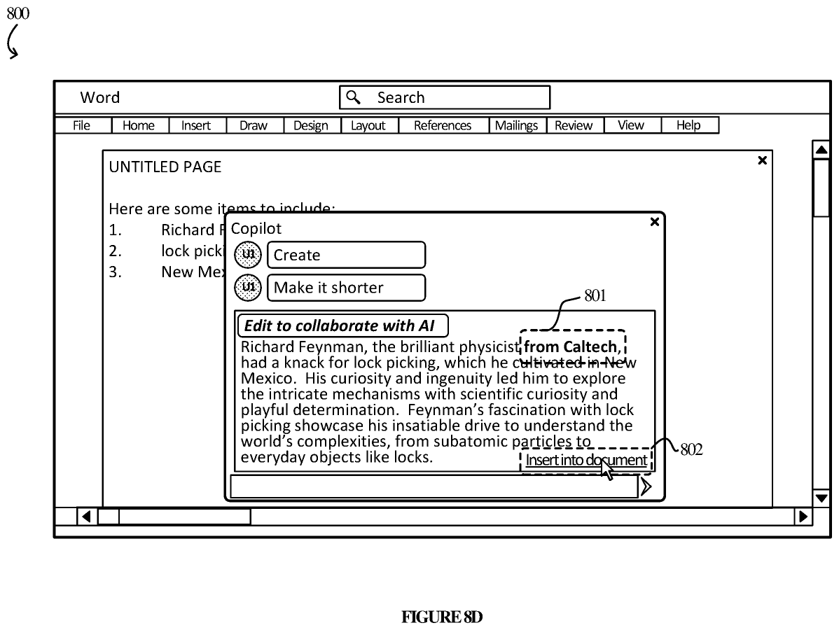

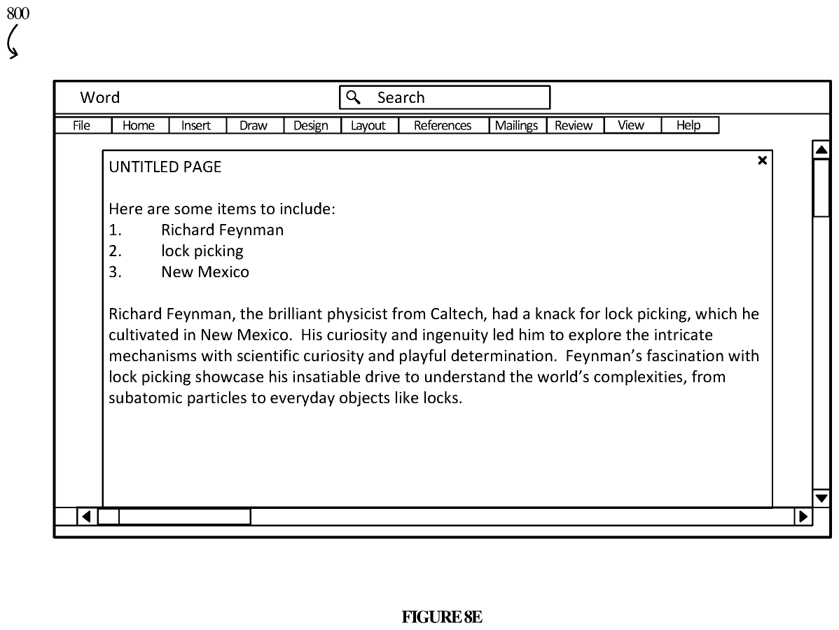

FIGS. 8A-8E illustrate operational scenario 800 of a collaborative prompt object for an LLM integration in an application in an implementation. In operational scenario 800, a user initiates display of a collaborative prompt object for LLM integration in an application environment of a word processing application. Upon launching the collaborative prompt object in the application environment, the collaborative prompt object generates a prompt for submission to an LLM which includes contextual information relating to the document opened in the application environment. The prompt tasks the LLM with inferring the user's intent from the contextual information and generating suggestions for additional content based on the inferred intent. As illustrated, the content of the document lists three items. The LLM returns four broad suggestions of content to be generated based on the three items. The four suggestions are configured by the collaborative prompt object as graphical buttons which the user can select in accordance with the user's intent. The collaborative prompt object also displays a text box for receiving user input for generating a follow-up prompt to the LLM should the suggestions be inapt for the user's intent. As illustrated in FIG. 8A, the user selects the graphical button labeled “Create.” Based on the user selection, the collaborative prompt object generates a follow-up prompt which includes the user selection, the contextual information relating to the document and the preceding interchange with the LLM.

Continuing operational scenario 800 in FIG. 8B, the LLM generates content in response to the follow-up prompt. The content includes text composed by the LLM incorporating the three items listed in the document. In FIG. 8B, the user keys in “Make it shorter” in response to the content generated by the LLM. Based on the user input, the collaborative prompt object generates a third prompt to the LLM including the user input, the contextual information, and the preceding exchanges with the LLM.

In FIG. 8C, the collaborative prompt object displays the preceding user inputs along with newly generated content based on the third prompt. The user clicks the hyperlink which causes the collaborative prompt object to transmit the newly generated content to the application hosting the document for insertion into the document. In FIG. 8D, the user modifies the generated content by keying in text 801. The user then selects hyperlink 802 to cause the collaborative prompt object to insert the generated and now modified content into the document. In FIG. 8E, the application environment displays the newly updated document including the generated and modified content.

FIG. 9 illustrates computing device 901 that is representative of any system or collection of systems in which the various processes, programs, services, and scenarios disclosed herein may be implemented. Examples of computing device 901 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 901 may be implemented as a single apparatus, system, or device or may be implemented in a distributed manner as multiple apparatuses, systems, or devices. Computing device 901 includes, but is not limited to, processing system 902, storage system 903, software 905, communication interface system 907, and user interface system 909 (optional). Processing system 902 is operatively coupled with storage system 903, communication interface system 907, and user interface system 909.

Processing system 902 loads and executes software 905 from storage system 903. Software 905 includes and implements collaborative prompting process 906, which is (are) representative of the collaborative prompting processes discussed with respect to the preceding Figures, such as processes 200 and 300. When executed by processing system 902, software 905 directs processing system 902 to operate as described herein for at least the various processes, operational scenarios, and sequences discussed in the foregoing implementations. Computing device 901 may optionally include additional devices, features, or functionality not discussed for purposes of brevity.

Referring still to FIG. 9, processing system 902 may comprise a micro-processor and other circuitry that retrieves and executes software 905 from storage system 903. Processing system 902 may be implemented within a single processing device but may also be distributed across multiple processing devices or sub-systems that cooperate in executing program instructions. Examples of processing system 902 include general purpose central processing units, graphical processing units, application specific processors, and logic devices, as well as any other type of processing device, combinations, or variations thereof.

Storage system 903 may comprise any computer readable storage media readable by processing system 902 and capable of storing software 905. Storage system 903 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 903 may also include computer readable communication media over which at least some of software 905 may be communicated internally or externally. Storage system 903 may be implemented as a single storage device but may also be implemented across multiple storage devices or sub-systems co-located or distributed relative to each other. Storage system 903 may comprise additional elements, such as a controller, capable of communicating with processing system 902 or possibly other systems.

Software 905 (including collaborative prompting process 906) may be implemented in program instructions and among other functions may, when executed by processing system 902, direct processing system 902 to operate as described with respect to the various operational scenarios, sequences, and processes illustrated herein. For example, software 905 may include program instructions for implementing a collaborative prompting process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtualization software, or other application software. Software 905 may also comprise firmware or some other form of machine-readable processing instructions executable by processing system 902.

In general, software 905 may, when loaded into processing system 902 and executed, transform a suitable apparatus, system, or device (of which computing device 901 is representative) overall from a general-purpose computing system into a special-purpose computing system customized to support collaborative prompting processes in an optimized manner. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary storage, as well as other factors.

For example, if the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 907 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 901 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon. Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A computing apparatus comprising:
one or more computer-readable storage media;
one or more processors operatively coupled with the one or more computer-readable storage media; and
program instructions stored on the one or more computer-readable storage media that, when executed by the one or more processors, direct the computing apparatus to at least:
identify a context of a content environment into which a local instance of a collaborative prompt object was inserted;
generate a prompt for a large language model (LLM) service to elicit suggestions for follow-on prompts based on content of the content environment; and
display, in the local instance, graphical input devices corresponding to the suggestions;
receive user input comprising a selection of a graphical input device of the graphical input devices; and
generate a follow-on prompt based on the suggestion corresponding to the selected graphical input device.

2. The computing apparatus of claim 1, wherein the program instructions further direct the computing apparatus to:
maintain a record of events indicative of prompts, replies from the LLM service, and user interaction with respect to the local instance of the collaborative prompt object; and
update one or more remote instances of the collaborative prompt object based on the record of events.

3. The computing apparatus of claim 2, wherein to update the one or more remote instances of the collaborative prompt object based on the record of events, the program instructions direct the computing apparatus to distribute the events, via a relay service, to the one or more remote instances of the collaborative prompt object.

4. The computing apparatus of claim 3, wherein the program instructions further direct the computing apparatus to synchronize changes to the content of the content environment through a collaboration service, wherein the collaboration service is different from the relay service.

5. The computing apparatus of claim 4, wherein the program instructions further direct the computing apparatus to direct the one or more remote instances of the collaborative prompt object to refrain from performing an event of the record of events.

6. The computing apparatus of claim 2, wherein the user interaction comprises a selection to insert content from a reply of the replies from the LLM service into the content of the content environment.

7. The computing apparatus of claim 2, wherein the content environment of the local instance of the collaborative prompt object is different from a content environment of a remote instance of the collaborative prompt object.

8. The computing apparatus of claim 2, wherein the program instructions further direct the computing apparatus to:
receive user input comprising a natural language input; and
generate a follow-on prompt based on the natural language input.

9. The computing apparatus of claim 2, wherein the content environment comprises a document of a word processing application.

10. One or more computer-readable storage media having program instructions stored thereon that, when executed by one or more processors operatively coupled with the one or more computer-readable storage media, direct a computing device to:
by a local instance of a collaborative prompt object in a document:
identify a context of a content environment into which a local instance of a collaborative prompt object was inserted;
generate a prompt for to a large language model (LLM) service to elicit suggestions for follow-on prompts based on content of the content environment;
display, in the local instance, graphical input devices corresponding to the suggestions;
receive user input comprising a selection of a graphical input device of the graphical input devices; and
generate a follow-on prompt based on the suggestion corresponding to the selected graphical input device.

11. The one or more computer-readable storage media of claim 10, wherein the program instructions further direct the computing device to:
maintain a record of events indicative of prompts, replies from the LLM service, and user interaction with respect to the local instance of the collaborative prompt object; and
update one or more remote instances of the collaborative prompt object based on the record of events.

12. The one or more computer-readable storage media of claim 11, wherein to update the one or more remote instances of the collaborative prompt object based on the record of events, the program instructions further direct the computing device to distribute the events, via a relay service, to the one or more remote instances of the collaborative prompt object.

13. The one or more computer-readable storage media of claim 12, wherein the program instructions further direct the computing device to synchronize changes to the content of the content environment through a collaboration service, wherein the collaboration service is different from the relay service.

14. The one or more computer-readable storage media of claim 13, wherein the program instructions further direct the computing device to direct the one or more remote instances of the collaborative prompt object to refrain from performing an event of the record of events.

15. The one or more computer-readable storage media of claim 11, wherein the user interaction comprises a selection to insert content from a reply of the replies from the LLM service into the content of the content environment.

16. A method comprising:
identifying a context of a content environment into which a local instance of a collaborative prompt object was inserted;
generating a prompt to a large language model (LLM) service to elicit suggestions for follow-on prompts based on content of the content environment;
displaying, in the local instance, graphical input devices corresponding to the suggestions;
receiving user input comprising a selection of a graphical input device of the graphical input devices; and
generating a follow-on prompt based on the suggestion corresponding to the selected graphical input device.

17. The method of claim 16, further comprising:
maintaining a record of events indicative of prompts, replies, and user interaction with respect to the local instance of the collaborative prompt object; and
updating one or more remote instances of the collaborative prompt object based on the record of events.

18. The method of claim 17, wherein updating the one or more remote instances of the collaborative prompt object based on the record of events comprises distributing, via a relay service, the events to the one or more remote instances of the collaborative prompt object.

19. The method of claim 18, further comprising synchronizing changes to the content of the content environment through a collaboration service.

20. The method of claim 19, further comprising directing the one or more remote instances of the collaborative prompt object to refrain from performing an event of the record of events.
